(19) United States
(12) Patent Application Publication
(10) Pub. No.: US 2022/0062853 A1
(43) Pub. Date: Mar. 3, 2022

(54) EVAPORATIVE LOSS CONTROL DEVICE

(71) Applicant: Arkema Inc., King of Prussia, PA (US)

(72) Inventors: Roderick Reber III, Maple Glen, PA (US); Denis Kato De Almeida, Philadelphia, PA (US)

(21) Appl. No.: 17/415,055

(22) PCT Filed: Nov. 26, 2019
(86) PCT No.: PCT/US19/63144

§ 371 Date: Jun. 17, 2021

Related U.S. Application Data
(60) Provisional application No. 62/781,804, filed on Dec. 19, 2018.

(51) Int. Cl. B01J 20/20; B01J 20/28; B01D 53/04

(52) U.S. Cl. CPC B01J 20/20; B01J 20/2803; B01J 20/28057; B01J 20/28004; B01D 53/0407; B01D 2253/306; B01J 2220/82; B01D 2253/102; B01D 2257/702; B01D 2253/25; B01J 2220/46

(57) ABSTRACT

The present disclosure is directed to a gas phase adsorption device comprising a large annulus and a small annulus block wherein the small annulus block is concentrically positioned inside the large annulus block. The present disclosure is also directed to a method for the storage of gas.

### FIELD

The present disclosure is related to a gas phase adsorption device having an adsorbent block in the shape of an annulus.

### BACKGROUND

Gas phase adsorption devices, such as Evaporative Loss Control Devices (ELCDs), composed by loose adsorbent media can be limited by axial flow design and subsequent adsorbent types, such as where the configuration has unfavorable pressure drop and adsorption efficiency. In addition, dust generated by the attrition of the loose media can be an issue. Dust generation has been addressed by the addition of fine filters and compression spring systems to limit the movement (and attrition) of the loose media in the containment. These extra features (e.g., filter, springs, others) add complexity to the design of the device and manufacturing costs.

Sequential, separated compartments of decreasing volume and/or adsorption capacity have been described.

The technology to convert low bulk density loose sorbent into an immobilized higher density block using a thermoplastic binder is well known for filtration applications. It is believed that high surface area sorption materials formed into high density compacted structures can achieve the economic storage volume needed for gases. The use of high performance binder materials takes the immobilization technology even further, providing higher packing densities and better manufacturing productivity, while maintaining the sorbents highest performance. The resulting devices made from the combination of the manufactured immobilized block by specific formulations of thermoplastic binder and adsorption media allow very high volume storage of gas per volume of device, but at a much lower pressure and cost compared to liquefying and compressed gas technologies widely used today.

### SUMMARY

The present disclosure is related to gas phase adsorption device comprising bound media, e.g., an adsorbent block, comprising: at least one large annulus block comprising a first adsorbent bound together by a first thermoplastic binder comprising first binder particles; and at least one small annulus block comprising a second adsorbent bound together by a second thermoplastic binder comprising second binder particles and wherein the at least one small annulus block is concentrically positioned inside the at least one large annulus.

Aspects of the Invention Include:

Aspect 1: A gas phase adsorption device comprising an adsorbent block, the adsorbent block comprising a large annulus block and at least one small annulus block, wherein the at least one small annulus block is concentrically positioned inside the large annulus block; wherein the large annulus comprises a first adsorbent bound together by a first thermoplastic binder comprising first binder particles; wherein the small annulus block comprises a second adsorbent bound together by a second thermoplastic binder comprising second binder particles.

Aspect 2: The gas phase adsorption device according to aspect 1, wherein the first binder particles in the large annulus block comprises 0.3 weight percent to 30 weight percent of the total weight of the large annulus block.

Aspect 3: The gas phase adsorption device according to any one of aspects 1-2, wherein the first binder particles of the large annulus block have a discrete particle size of between from 5 to 700 nm in size, preferably from 20 to less than 500 nm, more preferably from 50 to less than 400 nm.

Aspect 4: The gas phase adsorption device according to any one of aspects 1-3, wherein the second binder particles in the small annulus block comprises 0.3 weight percent to 30 weight percent of the total weight of the small annulus block.

Aspect 5: The gas phase adsorption device according to any one of aspects 1-4, wherein the second binder particles of the small annulus block have a discrete particle size of between from 5 to 700 nm in size, preferably from 50 to less than 500 nm, more preferably from 50 to less than 400 nanometers.

Aspect 6: The gas phase adsorption device according to any one of aspects 1-5, wherein the first binder particles and the second binder particles are the same or different in chemical composition.

Aspect 7: The gas phase adsorption device according to any one of aspects 1-6, wherein the first binder particles and the second binder particles are independently selected from the group consisting of fluoropolymers, styrene-butadiene rubbers (SBR), polyether ketoneketone (PEKK), polyether etherketone (PEEK), ethylene vinyl acetate (EVA), acrylic polymers, polymethyl methacrylate polymers and copolymers, polyurethanes, styrenic polymers, polyamides, polyolefins, polyethylene and copolymers thereof, polypropylene and copolymers thereof, polyesters, polyethylene terephthalate, polyvinyl chlorides, polycarbonate and thermoplastic polyurethane (TPU).

Aspect 8: The gas phase adsorption device according to any one of aspects 1-7 wherein the first binder particles and the second binder particles are independently selected from the group consisting of polyvinylidene fluoride homopolymer, polyvinylidene fluoride copolymers, and polyamide homopolymer and polyamide copolymers.

Aspect 9: The gas phase adsorption device according to any one of aspects 1 to 8, wherein the first binder particles in the large annulus block comprises 5 weight percent to 15 weight percent of the total weight of the large annulus block.

Aspect 10: The gas phase adsorption device according to any one of aspects 1 to 9, wherein the second binder particles in the at least one small annulus block comprises 5 weight percent to 15 weight percent of the total weight of the at least one small annulus block.

Aspect 11: The gas phase adsorption device according to any one of aspects 1-10, wherein the large annulus block is formed by an extrusion process and the small annulus block is formed independently, by an extrusion process.

Aspect 12: The gas phase adsorption device according to any one of aspects 1-10, wherein the large annulus block is formed by a compression molding process and the small annulus block is formed independently, by a compression molding process.

Aspect 13: The gas phase adsorption device according to any one of aspects 1-12, the first adsorbent makes up equal to or greater than 70 weight percent, preferably greater than 85 weight percent, more preferably greater than 90 weight percent of the large annulus block and the second adsorbent makes up equal to or greater than 70 weight percent, preferably greater than 85 weight percent, more preferably greater than 90 weight percent of the at least one small annulus block.

Aspect 14: The gas phase adsorption device according to any one of aspects 1-13, wherein the first adsorbent and the second adsorbent independently are selected from the group consisting of activated carbon, carbon fibers, molecular sieves, carbon molecular sieves, silica gel, and metal organic framework.

Aspect 15: The gas phase adsorption device according to any one of aspects 1-13, wherein the first adsorbent comprises activated carbon or carbon fibers.

Aspect 16: The gas phase adsorption device according to any one of aspects 1-13, wherein the second adsorbent media comprises activated carbon or carbon fibers.

Aspect 17: The gas phase adsorption device according to any one of aspects 1-15, wherein the first adsorbent is a different chemical composition than the second adsorbent.

Aspect 18: The gas phase adsorption device according to any one of aspects 1-16, wherein the first adsorbent is the same chemical composition as the second adsorbent.

Aspect 19: The gas phase adsorption device according to any one of aspects 1-18, wherein the at least one small annulus block has an average N₂ BET surface area per block unit volume of at least 10% less than that of the large annulus block.

Aspect 20: The gas phase adsorption device according to any one of aspects 1-18, wherein the large annulus block has an average N₂ BET surface area per block unit volume of at least 10% less than that of the small annulus block.

Aspect 21: The gas phase adsorption device according to any one of aspects 1-20, wherein the adsorbent block has the ability to adsorb hydrocarbon gases, such as butane.

Aspect 22: The gas phase adsorption device according to any one of aspects 1-20, wherein the large annulus block having an immobilized density greater than 1.1 times or preferably greater than 1.2 times or more preferably greater than 1.3 times that of the apparent density of the loss sorption media.

Aspect 23: The gas phase adsorption device according to any one of aspects 1-20, wherein the small annulus block having an immobilized density greater than 1.1 times or preferably greater than 1.2 times or more preferably greater than 1.3 times that of the apparent density of the loss sorption media.

### BRIEF DESCRIPTION OF THE FIGURES

FIG. 1 depicts a testing apparatus for measuring pressure drop for compression molded blocks.

FIG. 2 depicts the outside surface of a block as tested in Example 1.

FIG. 3 depicts a dual layer block as tested in Example 1.

FIG. 4 depicts a column and an annulus block and the theoretical packed bed of decreasing cross sectional area simulating the annulus block.

### DETAILED DESCRIPTION

The articles “a,” “an,” and “the” are used herein to refer to one or more than one (i.e., to at least one) of the grammatical object of the article. By way of example, “an element” means one element or more than one element.

The word “comprising” is used in a manner consistent with its open-ended meaning, that is, to mean that a given product or process can optionally also have additional features or elements beyond those expressly described. It is understood that wherever embodiments are described with the language “comprising,” otherwise analogous embodiments described in terms of “consisting of” and/or “consisting essentially of” are also contemplated and within the scope of this disclosure.

As used herein, the term “Interconnectivity” means that a sorbent, e.g., active particles or fibers, are permanently bonded together by the polymer binder particles without completely coating (e.g., about 10% to about 90% coated; about 20% to about 80% coated, or about 30% to about 70% coated) the active primary and secondary particles or functional particles or fibers. The binder adheres the sorbent at specific discrete points to produce an organized, porous structure. The porous structure allows a gas to pass through the interstitial space between the interconnected particles or fibers, and the gas is exposed directly to the surface(s) of the sorbent particles or fibers, favoring the adsorption of the gas onto the adsorbent material. Because the polymer binder adheres to the adsorbent particles in only discrete points, less binder is used for full connectivity compared to a binder that is coated onto the adsorbent.

Various examples and embodiments of the inventive subject matter disclosed here are possible and will be apparent to a person of ordinary skill in the art, given the benefit of this disclosure.

The present disclosure is directed to gas phase adsorption device comprising an adsorbent block wherein an adsorbent such as activated carbon particles and/or other loose adsorbent media are bound together by a thermoplastic polymeric binder into an annular freestanding block configuration. The gas flow can occur radially in an outside-in direction effectively mimicking a packed bed of decreasing cross sectional area and thus gas storage capacity. This configuration can allow for more efficient use of adsorbent media, as smaller adsorbent particles can be used in this configuration then can be used in an equivalent volume of loose granular bed device. Smaller particles have a much higher superficial surface area and are ostensibly more efficient adsorbents.

A gas phase adsorption device comprising an adsorbent block is disclosed. The adsorbent block comprises a large annulus block; and at least one small annulus block, wherein the at least one small annulus block is concentrically positioned inside the large annulus block; wherein the large annulus block comprises a first adsorbent bound together by a first thermoplastic binder particles; wherein the at least one small annulus block comprises a second adsorbent bound together by a second thermoplastic binder particles. The first and second binder particles can be the same or different. The first and second adsorbent can be the same or different.

The gas phase adsorption device can be made of a series of concentric annuluses fitting within each other. Where each annulus comprises adsorbent bound together by a thermoplastic binder particles. The absorbent of each annulus can be independently any of the adsorbents specified herein. The thermoplastic binder particles of each annulus can be any of the thermoplastic binder particles specified herein.

In certain embodiments, there is a spacing between the large annulus and the small annulus. In certain embodiments, there is no spacing between the large annulus and the small annulus (i.e., the large annulus and the small annulus are in substantially intimate contact).

In certain embodiments, the binder (chemical composition, concentration, and/or particle size) and the adsorbent (chemical composition, concentration, and/or particle size) can be the same for the large annulus and for the small annulus. In certain embodiments, the binder (chemical composition, concentration, and/or particle size) and the adsorbent (chemical composition, concentration, and/or particle size) can be different for the large annulus and for the small annulus. In certain embodiments, the binder (chemical composition, concentration, and/or particle size) can be the same for the large annulus and for the small annulus. In certain embodiments, the adsorbent for the large annulus can be activated carbon and the adsorbent for the small annulus can be activated carbon. In certain embodiments, the adsorbent for the large annulus can be activated carbon and the adsorbent for the small annulus can be an adsorbent other than activated carbon. In certain embodiments, the adsorbent for the small annulus can be activated carbon and the adsorbent for the large annulus can be an adsorbent other than activated carbon.

In certain embodiments the small annulus(s) can be denser per unit volume than the large annulus in order to maintain total surface area as the gas moves through. In some embodiments the large annulus can have a faster adsorption and the small annulus(s) can be densified for higher adsorption per unit volume as compared to the large annulus.

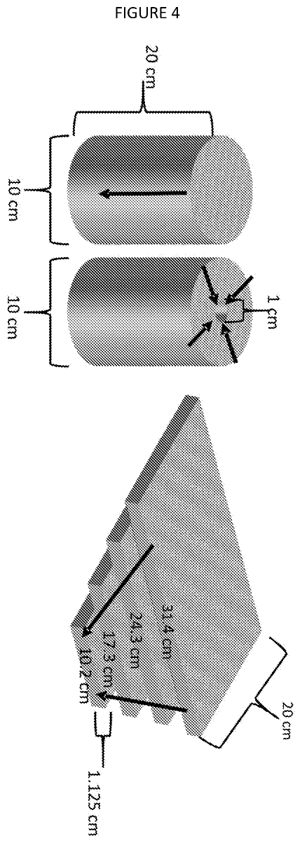

In certain embodiments, the present disclosure describes a gas phase adsorption process that is particularly aided by the annular geometry and, for example, by the decreasing cross sectional area in outside-in flow. All else being equal, the pressure drop for an annular packed bed is much lower than for a column of same size. As depicted in FIG. 4 an annulus block can be approximated by discrete beds of porous media each successive bed has a smaller cross sectional area then the one before it. An equation, such as the Kozeny-Carman equation, can be used to approximate the pressure drop of the two configurations of blocks. The pressure drop across the annular block is significantly less as compared to the pressure drop in a column. The pressure drop in the annular block can be more than an order of magnitude less than that in a column of same size.

The pressure drop in a radial flow device is inherently lower than in an axial flow device of equivalent volume of adsorbent. In certain embodiments, this lower pressure drop can enable the use of smaller particle size adsorbent, which can increase adsorption efficiency per a unit volume of the absorbent block.

Radial flow is the preferred flow pattern as it has a lower pressure drop than a column of equal size and radius. In certain embodiments, the pressure drop through the adsorbent block can be from 0.1 Pa to 1000 Pa. In certain embodiments, the pressure drop through the adsorbent block can be from 1 Pa to 100 Pa. In certain embodiments, the pressure drop through the adsorbent block can be from 5 Pa to 80 Pa.

The present disclosure provides immobilizing the adsorbent media with a thermoplastic polymeric binder, which may have the additional benefit of reducing dust generation, as compared to lose adsorbent media, from the evaporative loss control device. In certain embodiment, a dust generation reduction of from 1% to 99% or of from 10% to 90% can be achieved. In certain embodiments, a dust generation reduction of from 20% to 80% can be achieved.

The decreasing cross sectional area of an outside in annular block configuration creates a flow path that simulates a tapered cross section column. This configuration can simplify the overall design and manufacturing of an evaporate loss control device and may eliminate the need for multiple types of adsorbent.

In certain embodiments, smaller particles having a much higher superficial surface area can be more efficient adsorbents.

Embodiments of the present disclosure related to an adsorbent block comprising a large annulus block comprising a first outer diameter and a first inner diameter and a small annulus block comprising a second outer diameter and a second inner diameter, wherein the small annulus block is concentrically positioned inside the large annulus block.

Binder

In certain embodiments, the polymer particles of the present disclosure can be thermoplastic polymer particles in the sub-micrometer range.

The polymer particles of the composite of the invention are thermoplastic, elastomeric, thermoplastic volcanized (TPV), or thermoplastic elastomer (TPE) polymer particles with discrete particle sizes in the sub-micrometer range. The average discrete particle size of the binder is less than 1 micrometer, preferably less than 500 nm, preferably less than 400 nm, and more preferably less than 300 nm, with an aspect ratio of 1 to 1000. The average discrete particle size is generally at least 20 nm and preferably is higher for lower aspect ratio, i.e. at least 50 nm, most preferably at least 100 nm for aspect ratio of about 1 to 1000.

The polymer binder can have a discrete particle size of between 5 and less than 1000 nanometers, aspect ratio of 1 to 1000, and/or agglomerates between 1 and 150 micrometers.

The average discrete particle size can be less than 1 micrometer, preferably less than 700 nm, preferably less than 500 nm, preferably less than 400 nm, and more preferably less than 300 nm, with an aspect ratio of 1 to 1000. The average discrete particle size is generally at least 10 nm, at least 20 nm, at least 50 nm, most preferably at least 100 nm for aspect ratio of 1 to 1000. Binder particles are generally from 5 to 700 nm in size, preferably from 50 to less than 500 nm, preferably from 50 to 400 nm, and more preferably from 100-300 nm as an average discrete particle size. In some cases, polymer particles may agglomerate into 1 to 150 micrometer groupings, preferably 3-50 micrometers, or 5-15 micrometer agglomerates, but it has been found that these agglomerates can break into individual particles or fibrils during processing to an article. Some of the binder particles are discrete particles, and remain as discrete particles in the formed solid porous sorbent article. During processing into articles, the particles adjoin sorbent material together and provide interconnectivity.

In certain embodiments, polymers particles can include, but are not limited to fluoropolymers, styrene-butadiene rubbers (SBR), polyether ketoneketone (PEKK), polyether etherketone (PEEK), ethylene vinyl acetate (EVA), acrylic polymers such as polymethyl methacrylate polymer and copolymers, polyurethanes, styrenic polymers, polyamides, polyolefins, including polyethylene, and polypropylene and the copolymers thereof, polyester including polyethylene terephthalate, polyvinyl chlorides, polycarbonate and thermoplastic polyurethane (TPU). In certain embodiments, the thermoplastic polymers are made by emulsion (or inverse emulsion) polymerization. Preferably the polymers have a high molecular weight and higher viscosity to provide for interconnectivity, the higher viscosity results in lower flow, so as to not entirely coat the interactive particles.

In certain embodiments, polymer particles can be polyamides, polyether ketoneketone (PEKK), polyether etherketone (PEEK) and fluoropolymers, such as homopolymers and copolymers of polyvinylidene fluoride and polyamides.

The term fluoropolymer can denote any polymer that has in its chain at least one monomer chosen from compounds containing a vinyl group capable of opening in order to be polymerized and that contains, directly attached to this vinyl group, at least one fluorine atom, at least one fluoroalkyl group, or at least one fluoroalkoxy group. Useful fluoropolymers are thermoplastic homopolymers and copolymers having greater than 50 weight percent of fluoromonomer units by weight, preferably more than 65 weight percent, more preferably greater than 75 weight percent and most preferably greater than 90 weight percent of one or more fluoromonomers.

Examples of fluoromonomers include, but are not limited to of vinylidene fluoride (VDF orVF₂), tetrafluoroethylene (TFE), trifluoroethylene (TrFE), chlorotrifluoroethylene (CTFE), hexafluoropropene (HFP), vinyl fluoride (VF), hexafluoroisobutylene (HFIB), perfluorobutylethylene (PFBE), pentafluoropropene, 3,3,3-trifluoro-1-propene, 2-trifluoromethyl-3,3,3-trifluoropropene, fluorinated vinyl ethers including perfluoromethyl vinyl ether (PMVE), perfluoroethylvinyl ether (PEVE), ethylene tetrafluoroethylene (ETFE), ethylene fluoro trichloroethylene(ECTFE), perfluoropropylvinyl ether (PPVE), perfluorobutylvinyl ether (PBVE), 2,3,3,3-tetrafluoropropene, longer chain perfluorinated vinyl ethers, fluorinated dioxoles, such as perfluoro(1,3-dioxole); perfluoro(2,2-dimethyl-1,3-dioxole) (PDD), partially- or per-fluorinated alpha olefins of C₄ and higher, partially- or per-fluorinated cyclic alkenes of C₃ and higher, there copolymers and combinations thereof

Preferred fluoropolymers include polyvinylidene fluoride (PVDF) homopolymers and copolymers, polytetrafluoroethylene (PTFE) homopolymers and copolymers, terpolymers of tetrafluoroethylene and hexafluoropropylene (EFEP), terpolymers of poly(vinylidene fluoride tetrafluoroethylene-hexafluoropropylene), copolymers of vinyl fluoride; and blends of PVDF with polymethyl methacrylate (PMMA) polymers and copolymers, or thermoplastic polyurethanes. PMMA can be present at up to 49 weight percent based on the weight of the PVDF, and preferably from 5 to 25 weight percent. PMMA is melt-miscible with PVDF, and can be used to add hydrophilicity to the binder. A more hydrophilic composition provides for an increased water flow—resulting in less of a pressure drop across the composite article.

The PVDF may be a homopolymer, a copolymer, a terpolymer or a blend of a PVDF homopolymer or copolymer with one or more other polymers that are compatible with the PVDF (co)polymer. PVDF copolymers and terpolymers of the present disclosure can be those in which vinylidene fluoride units comprise greater than 40 percent of the total weight of all the monomer units in the polymer, such as greater than 70 percent of the total weight of the units.

In certain embodiments, vinylidene fluoride copolymers can have low crystallinity (or no crystallinity), making them more flexible than the semi-crystalline PVDF homopolymers. Flexibility of the binder allows it to better withstand the manufacturing process, as well as increased pull-through strength and better adhesion properties. In certain embodiments, copolymers can be those containing at least 50 mole percent, at least 75 mole %, at least 80 mole %, and at least 85 mole % of vinylidene fluoride copolymerized with one or more comonomers selected from the group consisting of tetrafluoroethylene, trifluoroethylene, chlorotrifluoroethylene, hexafluoropropene, vinyl fluoride, pentafluoropropene, tetrafluoropropene, trifluoropropene, perfluoromethyl vinyl ether, perfluoropropyl vinyl ether and any other monomer that would readily copolymerize with vinylidene fluoride.

Copolymers, terpolymers and higher polymers of vinylidene fluoride can be made by reacting vinylidene fluoride with one or more monomers from the group consisting of vinyl fluoride, trifluoroethene, tetrafluoroethene, one or more of partly or fully fluorinated alpha-olefins such as 3,3,3-trifluoro-1-propene, 1,2,3,3,3-pentafluoropropene, 3,3,3,4,4-pentafluoro-1-butene, and hexafluoropropene, the partly fluorinated olefin hexafluoroisobutylene, perfluorinated vinyl ethers, such as perfluoromethyl vinyl ether, perfluoroethyl vinyl ether, perfluoro-n-propyl vinyl ether, and perfluoro-2-propoxypropyl vinyl ether, fluorinated dioxoles, such as perfluoro(1,3-dioxole) and perfluoro(2,2-dimethyl-1,3-dioxole), allylic, partly fluorinated allylic, or fluorinated allylic monomers, such as 2-hydroxyethyl allyl ether or 3-allyloxypropanediol, and ethene or propene.

In certain embodiments, up to 30%, up to 25%, or up to 15% by weight of hexafluoropropene (HFP) units and 70%, 75%, or 85% by weight or more of VDF units can be present in the vinylidene fluoride polymer.

In certain embodiments, PVDF can be a representative small particle size binder.

The PVDF for use in the embodiments of the present disclosure can have a high molecular weight. In certain embodiments, high molecular weight can mean PVDF having a melt viscosity of greater than 1.0 kilopoise, such as greater than 5 Kp, from 15 to 50 Kp, and from 15 to 25 Kp, according to ASTM method D-3835 measured at 450° F. and 100 sec⁻¹. The high molecular weight PVDF can provide for interconnectivity, as it has a higher viscosity and lower flow, so it does not entirely coat the interactive particles.

PVDF used in accordance with embodiments of the present disclosure can generally prepared by means known in the art, using aqueous free-radical emulsion polymerization—although suspension, solution, and supercritical CO₂ polymerization processes may also be used.

The PVDF emulsion polymerization can result in a latex generally having a solids level of 10 to 60 percent by weight, such as 10 to 50 percent, and having a latex weight average particle size of less than 500 nm, such as less than 400 nm and less than 300 nm. The weight average particle size can be at least 20 nm, such as at least 50 nm. Additional adhesion promoters can also be added to improve the binding characteristics and provide connectivity that is non-reversible. A minor amount of one or more other water-miscible solvents, such as ethylene glycol, may be mixed into the PVDF latex to improve freeze-thaw stability.

The PVDF latex can be used in certain embodiments as a latex binder, or it may be dried to a powder by means known in the art, such as, but not limited to, spray drying, freeze-drying, coagulating, and drum drying. Smaller size PVDF powder particles can be useful, as they result in a decreased distance (higher density) of interactive particles. In an article formed directly from the PVDF emulsion, the emulsion particle can interact and adhere to two or more particles at discrete points on those particles. In an extrusion or compression molding process, the polymer resin particles can soften in the non-crystalline regions to adhere to the particles at discrete points, but do not melt to completely cover the particles.

In certain embodiments, the PVDF can have a density of about 1.78 g/cc.

In certain embodiments, polyvinylidene fluoride resins can include, but are not limited emulsion homopolymers or copolymers comprising polyvinylidene fluoropolymer, with a discrete particle size of between 20 nm and 1 micron, preferably 20 nm to less than 500 nm and a melt viscosity of between 5 and 100 kpoise, preferably 15 to 55 kpoise. The melt viscosity being measured by ASTM D3835 at 232° C. and 100 s⁻¹. Such polymers are sold by Arkema Inc. (King of Prussia, Pa.) under the trademark Kyblock™.

In certain embodiments, copolymers of VDF and HFP can be used. These copolymers have a lower surface energy. It is noted that PVDF in general has a lower surface energy than other polymers such as polyolefins. Lower surface energy can lead to better wetting of the interactive particle, and a more uniform dispersion. This can result in an improvement in the integrity of the separation device over a polymer binder with a higher surface energy, and can result in the need for a lower level of binder. Additionally, PVDF/HFP copolymers can have a lower crystallinity and a lower glass transition temperature (Tg), and therefore can be processed at a lower temperature in a melt process.

In certain embodiment, the PVDF polymer can be a functional PVDF, such as maleic anhydride-grafted PVDF from Arkema. The PVDF polymer can be functionalized with acid functionalized monomers as described in U.S. Pat. No. 9,434,837. Particularly useful acid functional monomers include, but are not limited to, acrylic acid, meth acrylic acid, vinyl sulfonic acid, vinyl phosphonic acid and itaconic acid and salts of each or combinations thereof. The functional PVDF can improve the binding to interactive particles or fibers, which can permit a lower level of PVDF loading in the formulation. This lower loading-excellent binding combination can improve the overall permeability of the porous separation or gas storage article.

Functional groups can be added to fluoropolymers in order to increase adhesion to other materials, improve wettability, and provide malleability. Functionality has been added by several means, such as, by direct copolymerization of a functional monomer into backbone of the fluoromonomers, and by a post-polymerization grafting mechanism, such as the grafting of maleic anhydride onto a polyvinylidene fluoride homopolymer or copolymer, as described in U.S. Pat. No. 7,241,817, the content of which is herein incorporated by reference. WO 2013/110740 and U.S. Pat. No. 7,351,498, the contents of which are herein incorporated by reference, further describe functionalization of a fluoropolymer by monomer grafting or by copolymerization. WO16149238 and US2016009840, the contents of which are herein incorporated by reference, further disclose functionalization of fluoropolymers by adding small levels of comonomer or functional chain transfer agent to the polymerization process. U.S. Pat. No. 9,434,837, the contents of which are herein incorporated by reference, discloses acid functionalized monomers useful in preparing fluoropolymer with acid functionality.

In certain embodiments, the minimum amount of binder is used that allows the adsorbent materials to hold together. This allows more of the surface area to be exposed and be active in gas absorption.

Adsorbent/Sorbents

The sorbents of the invention are those capable of adsorbing and desorbing specific gas molecules. The terms adsorbent and sorbent are used interchangeably. In one important embodiment of the invention, activated carbon is used to adsorb hydrocarbons such as butane, however, other sorbents with adsorption specificity for other gases are also contemplated by this invention. Examples of sorbants include, but are not limited to: metallic particles of 410, 304, and 316 stainless steel, copper, aluminum and nickel powders, ferromagnetic materials, activated alumina, activated carbon, carbon nanotubes, silica gel, acrylic powders and fibers, cellulose fibers, glass beads, various abrasives, common minerals such as silica, wood chips, ion-exchange resins, ceramics, zeolites, diatomaceous earth, polyester particles and fibers, and particles of engineering resins such as polycarbonate. such as in activated carbon, nano clays, or zeolite particles; ion exchange resins; catalysts; electromagnetic particles; acid or basic particles for neutralization; etc. Other useful sorbents include, but are not limited to: carbon molecular sieves, molecular sieves, silica gel, metal organic framework, etc. have special affinity to specific gas adsorption. Activated carbon, carbon fibers and molecular sieves are especially useful sorbents of the invention.

Activated carbon having a large level of surface area and pore volume is especially preferred, as are nano carbon fibers. Activated carbon having a high pore volume is also preferred. Activated carbon having pore sizes suitable for the adsorption of gases are especially preferred, containing micropores (less than 20 Å) and/or mesopores (20 to 500 Å). Gas adsorption is most effective in pores that have space for one to three layers of gas molecules, for instance with the size of gas molecules being typically between 3 and 5 Å (H2 3 Å, N2 3.5 Å, alkanes 4.5 Å), it is desirable that the sorbent has a least 30%, preferably at least 50% of pores in the range from 6 to 30 Å, and especially 6 to 18 Å, or 7 to 21 Å, or 9 to 27 Å, or 10 to 30 Å. Example activated carbon sorbants include, but are not limited to, BAX1100, BAX1500 and BAX1700, SA1500 from Ingevity (South Carolina), Ecosorb® FX1184 from Jacobi Carbons (Kalmar, Sweden) and activated carbon products from Kuraray (Osaka, Japan) such as its KG grade.

The sorbent particles of the invention are generally in the size range of 0.1 to 3,000 microns, preferably from 1 to 500 microns, and most preferably from 5 to 100 microns in diameter. In certain embodiments, sorbent particles have a multimodal particle size distribution, for instance with some particles having an average particle size of less than 100 microns, and some particles having an average particle size of more than 200 microns. Sorbent particles can also be in the form of fibers of 0.1 to 250 microns in diameter of essentially unlimited length to width ratio. Fibers are preferably chopped to no more than 5 mm in length per the setting on the equipment used to chop the fibers.

Sorbent fibers or powders should have sufficient thermal conductivity to allow heating of the powder mixtures. In addition, in an extrusion process, the particles and fibers must have melting points sufficiently above the melting point of the binder resin to prevent both substances from melting and producing a continuous melted phase rather than the usually desired multi-phase system.

There are many sources of activated carbon and various techniques to differentiate the performance of each activated carbon per application. Sources of activated carbon include, but are not limited to, coconut shell, bitumen, coal, grass, organic polymers, hard wood, and soft wood. Each product has their own characteristics which can affect gas sorption and desorption performance. It is known that for gas sorption onto activated carbon it is dependent on the close proximity to surface area contact coupled with Van der Waal's forces to attract gas molecules and temporarily store them until desorption occurs. Key characteristics of the activated carbon which impacts the volume of gas sorption is the macro-, micro-, meso-porosity of the carbon, and its N2 BET surface area. In general, high BET surface area of at least 1,400 m²/g is preferred, of at least 2,000 m²/g is especially preferred.

Low N₂ BET surface area is considered less than 1400 m²/g. while high N₂ BET surface area is considered greater than or equal to 1400 m²/g. The pore sizes of porous materials are categorized by International Union of Pure and Applied Chemistry (IUPAC) as follows. Pores with size of less than 2 nm in diameters are micropores, pores with size of between 2 nm and 50 nm are mesopores, and pores with size of more than 50 nm are macropores.

The articles of the invention differ from membranes. A membrane works by rejection filtration—having a specified pore size, and preventing the passage of particles larger than the pore size through the membrane. The articles of the invention instead rely on adsorption or absorption of by sorbants to hold materials passing through the device.

A property related to manufacturing with solid state extrusion or compression molding methods can be the apparent density, as measured by ASTM D2854.

The adsorbent block can be made of activated carbon or other gas absorbent, the adsorbent material being bound together by small discrete thermoplastic polymer binder particles to provide interconnectivity. The adsorbent block is generally present within a closed container, capable of holding a pressurized gas. The adsorbent and binder are combined under pressure and heat to produce a solid dense porous gas-adsorbent structure.

In certain embodiments, the first outer diameter of the large annulus block can be from 1 mm to 1000 mm. In certain embodiments the first outer diameter of the large annulus block can be from 10 mm to 500 mm. In certain embodiments, the first outer diameter of the large annulus block can be from 50 mm to 100 mm.

In certain embodiments, the first inner diameter of the large annulus block can be from 1 mm to 999 mm. In certain embodiments the first inner diameter of the large annulus block can be from 10 mm to 500 mm. In certain embodiments, the first inner diameter of the large annulus block can be from 50 mm to 100 mm.

In certain embodiments, the second outer diameter can be from 0.1 mm to 990 mm. In certain embodiments the second outer diameter can be from 1 mm to 400 mm. In certain embodiments, the second outer diameter can be from 5 mm to 80 mm.

In certain embodiments, the second inner diameter can be from 0.1 mm to 800 mm. In certain embodiments the second inner diameter can be from 1 mm to 400 mm. In certain embodiments, the second inner diameter can be from 5 mm to 80 mm.

In certain embodiments, the first outer diameter can be from 2 times to 20 times larger than the second outer diameter. In certain embodiments, the first outer diameter can be from 4 times to 15 times larger than the second outer diameter. In certain embodiments, the first outer diameter can be from 5 times to 10 times larger than the second outer diameter.

In certain embodiments, the first inner diameter can be from 2 times to 20 times larger than the second inner diameter. In certain embodiments, the first inner diameter can be from 4 times to 15 times larger than the second inner diameter. In certain embodiments, the first inner diameter can be from 5 times to 10 times larger than the second inner diameter.

### Process

The binder and adsorbent particles can be blended and processed by several methods. In certain embodiments, the binder particles can be in a powder form, which can be dry blended with the sorbent materials. Solvent or aqueous blends can be formed by known means. The ratio of polymer binder to adsorbent particles or sorbants is from 0.5-35 weight percent of polymer solids to 65 to 99.5 weight percent particles or sorbants, preferably from 1-30 weight percent of polymer solids to 99 to 70 weight percent particles or sorbants, more preferably from 5 to 20 weight percent binder and 95 to 80 adsorbants particles or sorbants. If less fluoropolymer is used, complete interconnectivity may not be achieved, and if more fluoropolymer is used, there is a reduction in contact between the interactive particles and the fluid passing through the separation article.

There are generally three methods to form a solid porous adsorbent article from a homogeneous mixture of the adsorbent and binder: 1) dry powder homogeneous blends which are compression molded, 2) dry powder homogeneous blends which are extruded, and 3) solvent or aqueous blends which are cast and dried.

Because a very dense solid adsorbent article can be useful, compression molding and extrusion processing at higher pressures can be used. The compression molding and extrusion processes can be practiced in a manner that causes a softening of the polymer binder particles, but does not cause them to flow to the point that they contact other polymer particles and form agglomerates or a continuous layer. To be effective in the contemplated end-uses, the polymer binder remains as discreet polymer particles that bind the adsorbent materials into an interconnected web, for good permeability. In a solvent system, individual polymer particles no longer exist, as they are dissolved and form a continuous coating over the adsorbent particles. The continuous coating reduces the amount of activated surface area available for adsorption on the particles, and can reduce their overall effectiveness.

The most economical solution for high quality and high output capacity can be utilizing the extrusion process which makes uniform and highly packed immobilized porous media.

An advantage of the extrusion can be that the adsorbent density can be fairly constant across the article, while a compression molded article tends to show a density gradient along the compression length of the article. It can be difficult to have a uniform packing density gradient on a compression molded article especially as the aspect ratio (length/diameter ratio) increases. An advantage of a compression molded process is that a large variety of shapes are available.

The polymer binder/adsorbent material can be formed into a porous block article in an extrusion process, such as that described in U.S. Pat. No. 5,331,037. The polymer binder/adsorbent material composite of the present disclosure can be dry-blended, optionally with other additives, such as processing aids, and extruded, molded or formed into articles.

Continuous extrusion under heat, pressure and shear can produce an infinite length 3-dimensional multi-phase profile structure. To form the continuous web of forced-point bonding of binder to the adsorbent materials, a combination of applied pressure, temperature, and shear is used. The composite blend is brought to a temperature above the softening temperature, but below the melting point, significant pressure applied to consolidate the materials, and enough shear to spread the binder and form a continuous web.

The extrusion process can produce a continuous block structure at any diameter and length desired. Lengths of 1 cm to hundreds of meters are possible with the right manufacturing equipment. The continuous solid block can then be cut into desired final lengths. Typical diameters of the solid blocks would be 15 cm or less, and more preferably 15 cm or less—though with the proper size die(s) larger diameter structures up to 1.5 meters and larger could be produced.

An alternative to a single, solid structure, is forming two or more structures—a solid rod, and one or more hollow block cylinders designed to nest together to form the larger structure. Once each annular or rod-shaped block component is formed, the components can be nested together to create a larger structure. This process can provide several advantages over the extrusion of a single large structure. The blocks with smaller cross-sectional diameter can be produced at a faster rate than producing a large, solid, single-pass block. The cooling profile can be better controlled for each of the smaller-cross sectional pieces. A further advantage of this concept may be reduced gas diffusion path lengths through the adsorbent blocks as the spacing between concentric blocks could serve as channels for rapid flow of gas.

### Properties

In certain embodiments, adsorbent blocks can be high density, porous, solid articles that maximize the volume of adsorbent to volume of the container ratio. High density is defined as 1.1 to 1.5 times the bulk density.

In certain embodiments, adsorbent blocks can be used within a closed container capable of holding a pressurized gas of up to 5000 psi. In certain embodiments, adsorbent block can fit with a narrow tolerance inside the container, to maximize the amount of adsorbent per container volume. The container can have an inlet which can be used to fill the container with gas (such as methane) and can have a discharge end where the gas can leave the container. In certain embodiments, the adsorbent material does not settle or move during use, such as to power a vehicle, as it is interconnected by the binder particles. Gas can be provided into the container under pressure, and be adsorbed and stored by the sorbent material. When the pressure is released, and the container opened to a lower pressure environment, the gas can desorb from the adsorbent material, and be used in the application.

In certain embodiments, the adsorbent block has an immobilized density greater than 1.1 times or greater than 2 times that of the apparent density of the sorption media. Densification can permit more storage capacity per unit volume.

In certain embodiments, the gas held in the adsorbent block can be used to power a vehicle. In certain embodiments, the container holding the composite can be for storage purposes to supply fuel to grill and stove burners, refrigerators, freezers, furnaces, generators, emergency equipment, etc.

### EXAMPLES

The compositions and methods described herein are now further detailed with reference to the following examples. These examples are provided for the purpose of illustration only and the embodiments described herein should in no way be construed as being limited to these examples. Rather, the embodiments should be construed to encompass any and all variations which become evident as a result of the teaching provided herein.

### Example 1: Preparation of Blocks Via Compression Molding and Pressure Drop Testing

A mixture of 12×25 mesh (^{˜}1.5 mm) wood based, gas phase adsorption carbon was blended in a stand mixer with Kyblock® FG-81. The blend composition was approximately 12% wt. Kyblock® binder and 88% wt. activated carbon. The mixture was loaded into an annular mold with an outside diameter of 6.3 cm and an inside diameter of 3.2 cm. The filled mold was heated for 1 hour at 230° C., and about 90 kg of compressive force was applied after heating. The part was ejected and trimmed to approximately 15 cm long.

The density of the dry compressed adsorbent block was low, about 0.35 g/cc which only slightly exceeded the bulk density of the adsorbent material.

Additionally, a smaller annulus was prepared under the same conditions and inserted into the inner diameter of the larger block. This combined block had an outside diameter of 6.3 cm, an inside diameter of 1 cm and a length of 14 cm. After sitting exposed and reaching equilibrium moisture composition, the block weighed 220 g giving it an apparent density of 0.47 g/cc. This higher apparent density is due to two factors: the relatively high binder level and the fact that the carbon is saturated with moisture.

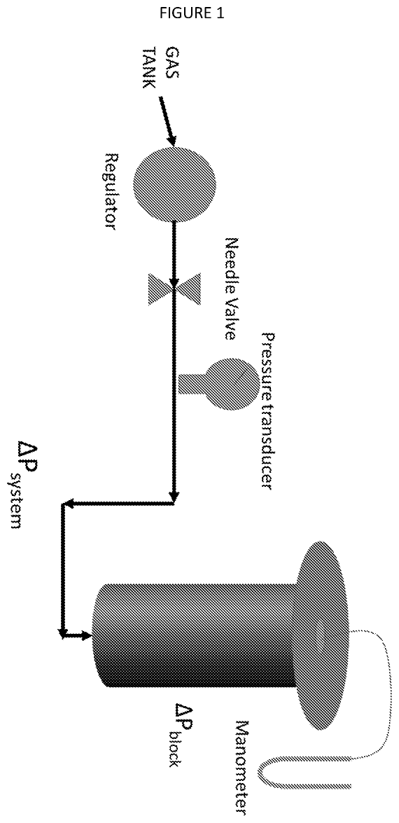

Measurement of pressure drop across blocks: The compression molded adsorbent blocks were clamped into a test fixture as pictured below in FIG. 1.

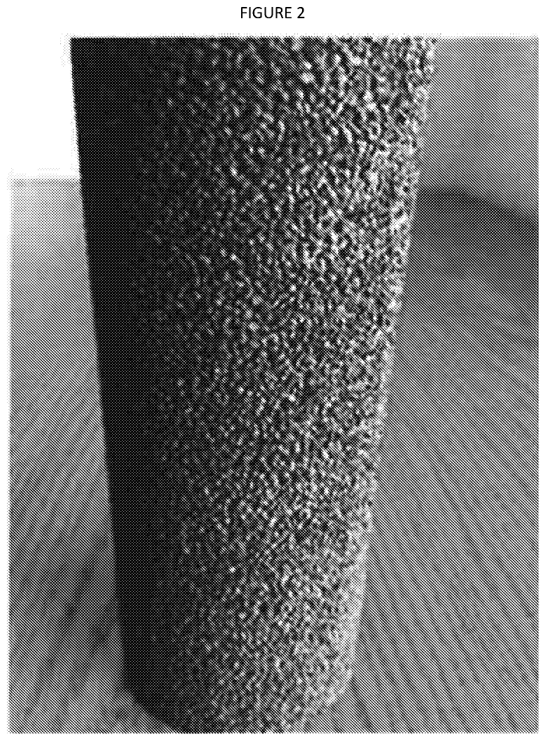

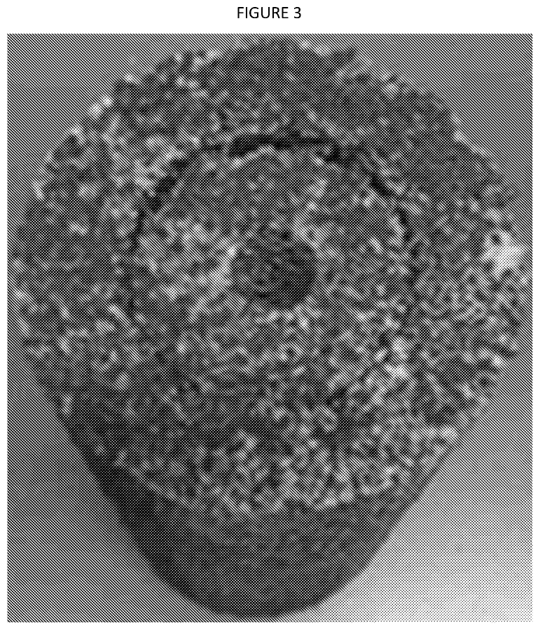

Results: The resulting blocks had relatively good retention of the activated carbon particles. Dusting was only apparent where the adsorbent block had been trimmed. Images of the two adsorbent blocks are shown as FIG. 2 and FIG. 3. FIG. 2 depicts the outside surface of the block. FIG. 3 depicts a dual layer block.

For the 6.3 cm×3.2 cm block, the pressure drop was monitored with the instrument's digital pressure transducer from 20-60 liters per minute of gas flow. As shown in Table 1, comparing pressure versus flow of the system with and without the block installed, there is little difference between the two; these data demonstrate that the adsorbent block imparts a very low pressure drop.

TABLE 1

| | |
|---|---|
| Open system | With block attached |

| Absolute | Gas | Absolute | Gas |
|---|---|---|---|
| pressure | flow | pressure | flow |
| (Pa) | (SLPM) | (Pa) | (SLPM) |
| 106000 | 21 | 106000 | 21 |
| 108000 | 30 | 108500 | 31 |
| 113000 | 41 | 112500 | 40 |
| 118500 | 50.5 | 118000 | 50 |
| 125000 | 61 | 124000 | 60 |

A second set of experiments was performed with a manometer attached to the interior of each block. At a flow rate of 70 liters per minute the pressure drop was about 2 mm of water for the 6.3 cm×3.2 cm bloc and about 1 cm of water for the 6.3 cm×1 cm block.

1. A gas phase adsorption device comprising an adsorbent block, the adsorbent block comprising:
a large annulus block; and at least one small annulus block,
wherein the at least one small annulus block is concentrically positioned inside the large annulus block;
wherein the large annulus comprises a first adsorbent bound together by a first thermoplastic binder comprising first binder particles; wherein the small annulus block comprises a second adsorbent bound together by a second thermoplastic binder comprising second binder particles, and
wherein the at least one small annulus block has an average N₂ BET surface area per block unit volume is at least 10% different than that of the large annulus block.

2. The gas phase adsorption device according to claim 1, wherein the first binder particles in the large annulus block comprises 0.3 weight percent to 30 weight percent of the total weight of the large annulus block block and wherein the second binder particles in the small annulus block comprises 0.3 weight percent to 30 weight percent of the total weight of the small annulus block.

3. The gas phase adsorption device according to claim 1, wherein the first binder particles of the large annulus block have a discrete particle size of between from 5 to 700 nm in size.

4. (canceled)

5. The gas phase adsorption device according to claim 1, wherein the second binder particles of the small annulus block have a discrete particle size of between from 5 to 700 nm in size.

6. The gas phase adsorption device according to claim 1, wherein the first binder particles and the second binder particles are different in chemical composition.

7. The gas phase adsorption device according to claim 1, wherein the first binder particles and the second binder particles are independently selected from the group consisting of fluoropolymers, styrene-butadiene rubbers (SBR), polyether ketoneketone (PEKK), polyether etherketone (PEEK), ethylene vinyl acetate (EVA), acrylic polymers, polymethyl methacrylate polymers and copolymers, polyurethanes, styrenic polymers, polyamides, polyolefins, polyethylene and copolymers thereof, polypropylene and copolymers thereof, polyesters, polyethylene terephthalate, polyvinyl chlorides, polycarbonate and thermoplastic polyurethane (TPU).

8. The gas phase adsorption device according to claim 1 wherein the first binder particles and the second binder particles are independently selected from the group consisting of polyvinylidene fluoride homopolymer, polyvinylidene fluoride copolymers, and polyamide homopolymer and polyamide copolymers.

9. The gas phase adsorption device according to claim 1, wherein the first binder particles in the large annulus block comprises 5 weight percent to 15 weight percent of the total weight of the large annulus block.

10. The gas phase adsorption device according to claim 1, wherein the second binder particles in the at least one small annulus block comprises 5 weight percent to 15 weight percent of the total weight of the at least one small annulus block.

11. (canceled)

12. (canceled)

13. The gas phase adsorption device according to claim 1, the first adsorbent makes up equal to or greater than 70 weight percent of the large annulus block and the second adsorbent makes up equal to or greater than 70 weight percent of the at least one small annulus block.

14. The gas phase adsorption device according to claim 1, wherein the first adsorbent and the second adsorbent independently are selected from the group consisting of activated carbon, carbon fibers, molecular sieves, carbon molecular sieves, silica gel, and metal organic framework.

15. The gas phase adsorption device according to claim 1, wherein the first adsorbent comprises activated carbon or carbon fibers.

16. The gas phase adsorption device according to claim 1, wherein the second adsorbent media comprises activated carbon or carbon fibers.

17. The gas phase adsorption device according to claim 1, wherein the first adsorbent is a different chemical composition than the second adsorbent.

18. The gas phase adsorption device according to claim 1, wherein the first adsorbent is the same chemical composition as the second adsorbent.

19. The gas phase adsorption device according to claim 1, wherein the at least one small annulus block has an average N₂ BET surface area per block unit volume of at least 10% less than that of the large annulus block.

20. The gas phase adsorption device according to claim 1, wherein the large annulus block has an average N₂ BET surface area per block unit volume of at least 10% less than that of the small annulus block.

21. The gas phase adsorption device according to claim 1, wherein the adsorbent block has the ability to adsorb hydrocarbon gases.

22. The gas phase adsorption device according to claim 1, wherein the large annulus block having an immobilized density greater than 1.1 times that of the apparent density of the loss sorption media.

23. The gas phase adsorption device according to claim 1, wherein the small annulus block having an immobilized density greater than 1.1 times that of the apparent density of the loss sorption media.
